(19) United States
(12) Patent Application Publication
(10) Pub. No.: US 2013/0140117 A1
(43) Pub. Date: Jun. 6, 2013

(54) VALVE STRUCTURE OF SHOCK ABSORBER

(71) Applicant: Chun Sung YU, Jeonbuk (KR)

(72) Inventor: Chun Sung YU, Jeonbuk (KR)

(21) Appl. No.: 13/485,354

(22) Filed: May 31, 2012

(30) Foreign Application Priority Data
May 31, 2011 (KR) 10-2011-0051903

(51) Int. Cl. F16F 9/512; F16F 9/34

(52) U.S. Cl. CPC F16F 9/5126; F16F 9/3405
USPC 188/280

(57) ABSTRACT

Disclosed herein is a valve structure of a shock absorber which respectively controls damping force at a low amplitude and a high amplitude when a piston valve is compressed and expanded and thus simultaneously satisfies ride comfort and stability of a vehicle. The valve structure of the shock absorber which has a cylinder filled with a working fluid and a piston rod provided with one end located within the cylinder and the other end extending to the outside of the cylinder, includes a main piston valve assembly installed at the end of the piston rod and operated to generate damping force varied according to moving velocity under the condition that the inside of the cylinder is divided into an upper chamber and a lower chamber, and a sub piston valve assembly moving together with the main piston valve assembly to generate damping force varied according to frequency.

### CROSS-REFERENCE TO RELATED APPLICATION

This application claims the benefit of Korean Patent Application No. 2011-0051903, filed on May 31, 2011 in the Korean Intellectual Property Office, the disclosure of which is incorporated herein by reference.

### BACKGROUND

1. Field

Embodiments of the present invention relate to a valve structure of a shock absorber which respectively controls damping force at a low amplitude and a high amplitude when a piston valve is compressed and expanded and thus simultaneously satisfies ride comfort and stability of a vehicle.

2. Description of the Related Art

In general, a damping device damping impact or vibration applied to an axle from the road surface during driving to improve ride comfort is installed in a vehicle, and a shock absorber is used as one such damping device.

The shock absorber is operated according to vibration of the vehicle corresponding to the state of the road surface, and damping force generated from the shock absorber is varied according to operating velocity of the shock absorber, i.e., according to whether or not the operating velocity of the shock absorber is high or low.

Ride comfort and driving stability of the vehicle may be controlled by adjustment of damping characteristics generated from the shock absorber. Therefore, when the vehicle is designed, adjustment of damping force of the shock absorber is important.

A conventional piston valve is designed to have regular damping characteristics at a high velocity, a middle velocity and a low velocity using a single flow channel, and thus, if damping force at the low velocity is lowered to facilitate improvement of ride comfort, damping force at the high and middle velocity may be lowered. Further, the conventional shock absorber is configured such that damping force thereof is varied according to change of the velocity of the piston regardless of frequencies or strokes. Such damping force changed only according to the change of the velocity of the piston is equal in various road surface states, and may thus cause a difficulty of satisfying ride comfort and stability simultaneously.

Therefore, research and development of a valve structure of a shock absorber, damping force of which may be varied according to various road surface states, i.e., excitation frequencies and strokes, to simultaneously satisfy ride comfort and stability of a vehicle has been required.

### SUMMARY

Therefore, it is an aspect of the present invention to provide a valve structure of a shock absorber which includes a main piston valve generating damping force varied according to moving velocity of a piston and a sub piston valve generating damping force varied according to frequency and thus simultaneously satisfies ride comfort and stability of a vehicle.

Additional aspects of the invention will be set forth in part in the description which follows and, in part, will be obvious from the description, or may be learned by practice of the invention.

In accordance with one aspect of the present invention, a valve structure of a shock absorber which has a cylinder filled with a working fluid and a piston rod provided with one end located within the cylinder and the other end extending to the outside of the cylinder, includes a main piston valve assembly installed at the end of the piston rod and operated to generate damping force varied according to moving velocity under the condition that the inside of the cylinder is divided into an upper chamber and a lower chamber, and a sub piston valve assembly moving together with the main piston valve assembly to generate damping force varied according to frequency.

The sub piston valve assembly may include a free piston, the moving distance of which is varied according to frequency.

The sub piston valve assembly may further include a hollow housing fixing a sub piston body to the lower portion of the main piston valve assembly, and a connection passage formed within the piston rod so as to communicate an inner space of the housing with the upper chamber. The free piston may be supported by an upper elastic unit and a lower elastic unit so as to be movable vertically according to frequency within the inner space of the housing, and at least one slit may be formed on the inner surface of the housing. The upper elastic unit and the lower elastic unit may be one selected from the group consisting of a spring, a disc and a clip, which support the free piston by elasticity.

The length of the slit may be greater than the thickness of a portion of the free piston contacting the inner surface of the housing, and if the upper and lower elastic units are upper and lower springs, the moduli of elasticity of the upper and lower springs may be different.

The main piston valve assembly may include a main piston body provided with at least one main compression passage through which the working fluid passes when the shock absorber is compressed and at least one main rebound passage through which the working fluid passes when the shock absorber is expanded, a main compression valve unit arranged on the main piston body and generating damping force against pressure of the working fluid having passed through the at least one main compression passage, and a main rebound valve unit arranged under the main piston body and generating damping force against pressure of the working fluid having passed through the at least one main rebound passage.

The sub piston valve assembly may further include a sub piston body provided with at least one sub compression passage through which the working fluid passes when the shock absorber is compressed and at least one sub rebound passage through which the working fluid passes when the shock absorber is expanded, a sub compression valve unit arranged on the sub piston body and generating damping force against pressure of the working fluid having passed through the at least one sub compression passage, and a sub rebound valve unit arranged under the sub piston body and generating damping force against pressure of the working fluid having passed through the at least one sub rebound passage.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a cross-sectional view of a valve structure of a shock absorber in accordance with an embodiment of the present invention;

FIG. 2 is a cross-sectional view of an essential portion illustrating flow of a fluid through the valve structure of the shock absorber in accordance with the embodiment of the present invention when amplitude is low; and

FIG. 3 is a cross-sectional view of the essential portion illustrating flow of the fluid through the valve structure of the shock absorber in accordance with the embodiment of the present invention when amplitude is high.

### DETAILED DESCRIPTION

Reference will now be made in detail to the embodiments of the present invention, examples of which are illustrated in the accompanying drawings, wherein like reference numerals refer to like elements throughout.

Hereinafter, a valve structure of a shock absorber in accordance with an embodiment of the present invention will be described with reference to the accompanying drawings.

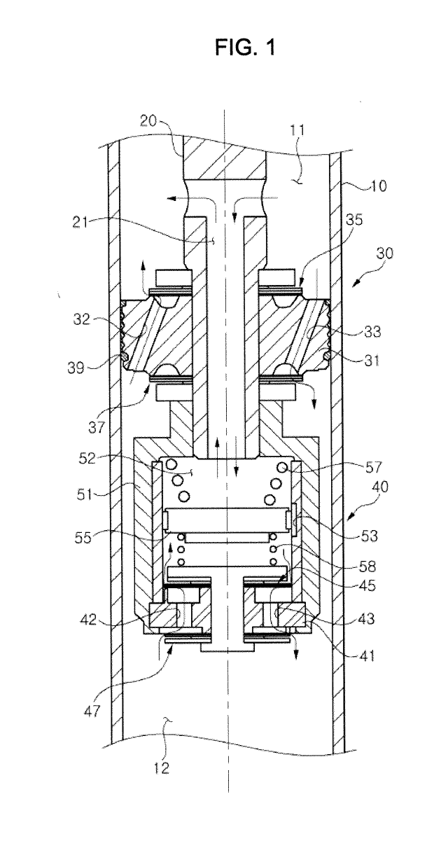

As shown in FIG. 1, the shock absorber provided with the valve structure in accordance with the embodiment of the present invention includes a cylinder 10 having a nearly cylindrical shape and filled with a working fluid, such as oil, and a piston rod 20 provided with one end located within the cylinder 10 and the other end extending to the outside of the cylinder 10.

The valve structure of the shock absorber in accordance with the embodiment of the present invention includes a main piston valve assembly 30 installed at the end of the piston rod 20 and operated to generate damping force varied according to moving velocity under the condition that the inside of the cylinder 10 is divided into an upper chamber 11 and a lower chamber 12, and a sub piston valve assembly 40 moving together with the main piston valve assembly 30 to generate damping force varied according to frequency.

The main piston valve assembly 30 and the sub piston valve assembly 40 are successively installed at the end of the piston rod 20. The other end of the piston rod 20 is slidable on a rod guide and an oil seal and simultaneously passes through the rod guide and the oil seal to achieve liquid tightness and extends to the outside of the cylinder 10.

The main piston valve assembly 30 may include a main piston body 31 provided with at least one main compression passage 32 through which the working fluid passes when the shock absorber is compressed and at least one main rebound passage 33 through which the working fluid passes when the shock absorber is expanded, a main compression valve unit 35 arranged on the main piston body 31 and generating damping force against pressure of the working fluid having passed through the main compression passage 32, and a main rebound valve unit 37 arranged under the main piston body 31 and generating damping force against pressure of the working fluid having passed through the at least one main rebound passage 33.

Further, a band 39 made of Teflon to prevent close adhesion with the inner circumferential surface of the cylinder 10 and abrasion of the main piston body 31 may be installed on the outer circumferential surface of the main piston body 31.

The sub piston valve assembly 40 includes a sub piston body 41 provided with at least one sub compression passage 42 through which the working fluid passes when the shock absorber is compressed and at least one sub rebound passage 43 through which the working fluid passes when the shock absorber is expanded, a sub compression valve unit 45 arranged on the sub piston body 41 and generating damping force against pressure of the working fluid having passed through the at least one sub compression passage 42, and a sub rebound valve unit 47 arranged under the sub piston body 41 and generating damping force against pressure of the working fluid having passed through the at least one sub rebound passage 43.

The sub piston valve assembly 40 includes a hollow housing 51 fixing the sub piston body 41 to the lower portion of the main piston valve assembly 30, a connection passage 21 formed within the piston rod 20 so as to communicate an inner space 52 of the housing 51 with the upper chamber 11, and a free piston 55 moving vertically according to frequency (amplitude) within the inner space 52 of the housing 51.

The free piston 55 is supported within the inner space 52 of the housing 51 by an upper spring 47 serving as an upper elastic unit and a lower spring 58 serving as a lower elastic unit, and at least one slit 53 is formed on the inner surface of the housing 51. The upper elastic unit and the lower elastic unit may be one selected from the group consisting of a spring, a disc and a clip, but may use any member which may support the free piston 55 by elasticity.

In a state in which external force is not applied, the free piston 55 is maintained at a height where the slit 53 is formed and thus allows the working fluid to freely flow through the slit 53.

For this purpose, the length of the slit 53 is greater than the thickness of a portion of the free piston 55 contacting the inner surface of the housing 51. The shapes and moduli of elasticity of the upper spring 57 and the lower spring 58 as the elastic units may be different, and may be variously modified during the design stage.

Hereinafter, operation of the valve structure in accordance with the embodiment of the present invention will be described with reference to FIGS. 1 to 3.

In FIG. 1, arrows shown at the left side of the central line represent flow of the working fluid when the compressing operation of the shock absorber is carried out, and arrows shown at the right side of the central line represent flow of the working fluid when the expanding operation of the shock absorber is carried out.

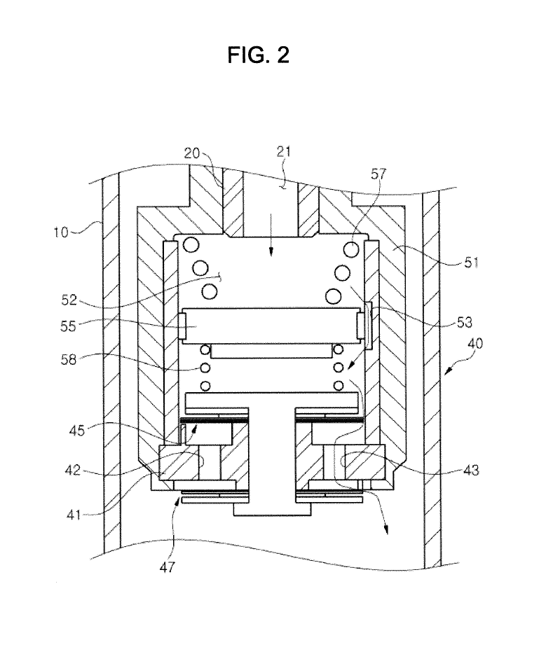

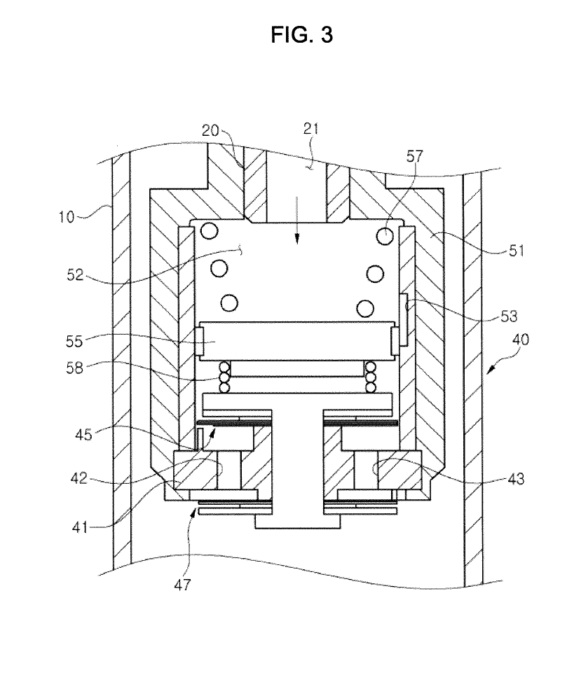

FIG. 2 illustrates the position of the free piston 55 at a high frequency (i.e., at a low amplitude), and FIG. 3 illustrates the position of the free piston 55 at a low frequency (i.e., at a high amplitude). The free piston 55 may move while compressing the upper spring 57 or the lower spring 58 if external force, i.e., inertia or pressure of the working fluid, is applied to the free piston 55. That is, if the intensity of external force applied to the free piston 55 is sufficiently high to compress the upper spring 57 or the lower spring 58, the free piston 55 moves upwards or downwards.

FIG. 2 illustrates a state in which the amplitude of the piston rod 20 of the shock absorber is low and the frequency of the piston rod 20 is high, and thus the intensity of external force applied to the free piston 55 is not sufficiently high to compress the upper spring 57 or the lower spring 58. Here, the working fluid of the upper chamber 11 may flow to the lower chamber 12 via the connection passage 21 formed within the piston rod 20, the slit 53 formed on the inner surface of the housing 51, and the sub piston valve assembly 40. Of course, flow of the working fluid from the lower chamber 12 to the upper chamber 11 is possible. At the high frequency and low amplitude, as described above, damping force may be obtained by the main piston valve assembly 30 and the sub piston valve assembly 40.

FIG. 3 illustrates a state in which the amplitude of the piston rod 20 of the shock absorber is high and the frequency of the piston rod 20 is low, and thus the intensity of external force applied to the free piston 55 is sufficiently high to compress the upper spring 57 or the lower spring 58. At a point of time when the free piston 55 moves and passes through the slit 53, the slit 53 is closed and flow of the working fluid is not possible. Here, the working fluid of the upper chamber 11 may flow to the connection passage 21 formed within the piston rod 20 and the inner surface 52 of the housing 51, but does not flow any more because the slit 53 is closed by the free piston 55, thereby increasing damping force.

Although FIG. 3 illustrates only the state of the shock absorber during the expanding operation, even if the amplitude of the piston rod 20 of the shock absorber is high and the frequency of the piston rod 20 is low during the compressing operation and thus the intensity of external force applied to the free piston 55 is sufficiently high to compress the upper spring 57, the slit 53 is closed by the free piston 55 and the working fluid of the lower chamber 12 does not flow to the upper chamber 11.

At the low frequency and high amplitude like this, the working fluid may flow only through the main piston valve assembly 30 and thus damping force may be obtained only by the sub piston valve assembly 40.

As is apparent from the above description, a valve structure of a shock absorber in accordance with an embodiment of the present invention includes a main piston valve generating damping force varied according to moving velocity of a piston and a sub piston valve generating damping force varied according to frequency.

Thereby, the valve structure of the shock absorber in accordance with the embodiment of the present invention may simultaneously satisfy ride comfort and stability of a vehicle.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A valve structure of a shock absorber which has a cylinder filled with a working fluid and a piston rod provided with one end located within the cylinder and the other end extending to the outside of the cylinder, the valve structure comprising:
a main piston valve assembly installed at the end of the piston rod and operated to generate damping force varied according to moving velocity under the condition that the inside of the cylinder is divided into an upper chamber and a lower chamber; and
a sub piston valve assembly moving together with the main piston valve assembly to generate damping force varied according to frequency,
wherein the sub piston valve assembly includes:
a free piston, the moving distance of which is varied according to frequency, a hollow housing fixing a sub piston body to the lower portion of the main piston valve assembly, and a connection passage formed within the piston rod so as to communicate an inner space of the housing with the upper chamber;
the free piston is supported by an upper elastic unit and a lower elastic unit so as to be movable vertically according to frequency within the inner space of the housing; and
at least one slit is formed on the inner surface of the housing.

2. The valve structure according to claim 1, wherein:
the free piston is maintained at a height where the slit is formed, in a state in which external force is not applied to the free piston; and
the length of the slit is greater than the thickness of a portion of the free piston contacting the inner surface of the housing so as to facilitate free flow of the working fluid through the slit.

3. The valve structure according to claim 1, wherein:
the upper elastic unit and the lower elastic unit are one selected from the group consisting of a spring, a disc and a clip, which support the free piston by elasticity; and
if the upper and lower elastic units are upper and lower springs, the moduli of elasticity of the upper and lower springs are different.

4. The valve structure according to claim 1, wherein the main piston valve assembly includes a main piston body provided with at least one main compression passage through which the working fluid passes when the shock absorber is compressed and at least one main rebound passage through which the working fluid passes when the shock absorber is expanded, a main compression valve unit arranged on the main piston body and generating damping force against pressure of the working fluid having passed through the at least one main compression passage, and a main rebound valve unit arranged under the main piston body and generating damping force against pressure of the working fluid having passed through the at least one main rebound passage.

5. The valve structure according to claim 1, wherein the sub piston valve assembly further includes a sub piston body provided with at least one sub compression passage through which the working fluid passes when the shock absorber is compressed and at least one sub rebound passage through which the working fluid passes when the shock absorber is expanded, a sub compression valve unit arranged on the sub piston body and generating damping force against pressure of the working fluid having passed through the at least one sub compression passage, and a sub rebound valve unit arranged under the sub piston body and generating damping force against pressure of the working fluid having passed through the sub rebound passage.
